(19) United States
(12) Patent Application Publication
(10) Pub. No.: US 2013/0159973 A1
(43) Pub. Date: Jun. 20, 2013

(54) ACTIVATION LOGIC GENERATION FOR A SOFTWARE APPLIANCE

(71) Applicant: International Business Machines Corporation, Armonk, NY (US)

(72) Inventors: Giuseppe Ciano, Roma (IT); Luigi Pichetti, Rome (IT); Antonio M. Sgro, Girifalco (IT)

(73) Assignee: INTERNATIONAL BUSINESS MACHINES CORPORATION, Armonk, NY (US)

(21) Appl. No.: 13/686,474

(22) Filed: Nov. 27, 2012

(30) Foreign Application Priority Data
Dec. 14, 2011 (EP) 11193439.4

(51) Int. Cl. G06F 9/44

(52) U.S. Cl. CPC G06F 8/71
USPC 717/121

(57) ABSTRACT

Embodiments relate to generating an activation logic component for a software appliance. An aspect includes analyzing configuration settings of a software component, the software component being installed in a first system environment. Another aspect includes generating an image-based installation version of the software component for a second system environment, the second system environment being distinct from the first system environment. Yet another aspect includes generating an activation logic component, such that the image-based installation version of the software component and the activation logic component are generated by an activation logic generator.

### CROSS-REFERENCE TO RELATED APPLICATION

This application claims the benefit of priority under 35 U.S.C. §119 to European Patent Application No. 11193439.4, filed on Dec. 14, 2011, which is herein incorporated by reference in its entirety.

### BACKGROUND

This disclosure relates generally to computer software, and more particularly to generation of an activation logic component for a software appliance.

Enterprise software systems may be installed in virtual computing environments rather than directly on physical servers. Software appliances play a key role in distributing software applications, including configuration parameters, for a specific system environment. Software appliances, or virtual appliances, are pre-built software solutions, including one or more virtual machines that are packaged, updated, maintained and managed as a unit. Unlike a traditional hardware appliance, these software appliances may let customers easily acquire, deploy, and manage pre-integrated solutions stacks, simplifying software deployment, distribution, and management. Virtual appliances may change the software distribution paradigm, allowing application builders to optimize the software stack for their application(s) and deliver a turn-key software service to the end user.

In a virtual data center, the deployment of appliances may require multiple configuration blocks to be performed in order to get the virtual appliance up and running. These configuration blocks may include (1) re-configurations needed to assign operating system specific parameters, for example, network information, which may include internet protocol (IP) addresses, a hostname, and security settings; and, (2) re-configurations to establish and/or remove a communication between different components of the same product running in different virtual machines, and/or different product components running in different virtual machines.

Appliance configurations may be performed manually, invoking predefined scripts with static values as input, or they may be performed automatically using technologies such as the international business machines (IBM) activation engine. It is possible to exploit various technologies in order to create an image-based installation of a product that may be re-configured by consumer at activation time, using, for example, the IBM Service Delivery Manager product. Image-based installation of a product may be created using manual operations and performing custom and complex ad-hoc searches. These searches may be directed to specific computing system environment variables, for example, network addresses, hostname, and/or security settings. However, this approach may not be optimized and cannot be re-used effectively for other products that may share the same middleware. Automated software distribution may also be cumbersome due to required manual blocks.

### SUMMARY

Embodiments include a method, system, and computer program product for generating an activation logic component for a software appliance. An aspect includes analyzing configuration settings of a software component, the software component being installed in a first system environment. Another aspect includes generating an image-based installation version of the software component for a second system environment, the second system environment being distinct from the first system environment. Yet another aspect includes generating an activation logic component, such that the image-based installation version of the software component and the activation logic component are generated by an activation logic generator.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 shows a flowchart of an embodiment of a method for activation logic generation for a software appliance.

FIG. 2 shows a flowchart of an embodiment of a method for manually building a software appliance and an activation script.

FIG. 3 shows a flowchart of an embodiment of a method for automatic generation of an activation logic component in the context of building a software appliance.

FIG. 4 shows a block diagram of an embodiment of an activation logic generator.

FIG. 5 shows an embodiment of a computing system that may be used in conjunction with embodiments of activation logic generation for a software appliance.

### DETAILED DESCRIPTION

Embodiments of activation logic generation for a software appliance are provided, with exemplary embodiments being discussed below in detail. Activation logic for a software applicant may be generated by analyzing configuration settings of a software component, which is installed in a first system environment, generating an image-based installation version of the software component for a system environment different to the first system environment, and generating an activation logic component, such that the image-based installation version of the software component and the activation logic are generated by an activation logic generator. The activation logic component, which may be a script and which may be able to activate the image-based installation version in a system environment different to the first system environment, may be executed automatically, i.e., without any human intervention.

In some embodiments, the software component may be a software product that may be installed directly on a physical server that runs an operating system. In other embodiments, the software component may be installed in a virtual environment using a hypervisor on which an operating system may be installed. The system environment different to the first system environment may be a target computing system that may deploy on a hypervisor. An image of the software may be distributed to the target computing system; however, the image may not be activated without a number of setting adjustments.

An activation logic may for activating an image may be located inside the image in order to adapt the image to a specific target system in some embodiments. In other embodiments, an activation logic component may be an automatically generated script to activate the software image in a target system environment completely automatically. In such an embodiment all required parameters may be identified automatically and without any human intervention.

The term “activation logic component” as used herein may, in some embodiments, refer to a series of instructions appropriate for activating an image in a target environment. Such a series of instructions or an activation script may have been generated manually. Using the system and method described herein, such an activation logic component may also be generated automatically.

The term “software appliance” as used herein may, in some embodiments, refer to one or more software components, e.g., a traditional software product—like, e.g., an order entry system or, a customer management system—may be pre-configured and pre-integrated with an operating system, building a software appliance. Instead of only one software program product, a plurality of software products may be pre-installed and pre-configured on the operating system to form a software appliance and may be distributed as an image requiring only a minimum set of final adaptations for an activation in a target system environment.

The term “image-based installation version” as used herein may, in some embodiments, refer to a software product, which may have been converted to an activatable image, or a software appliance, which may also comprise an operating system. In a technical term, such an image-based installation version may be referred to simply as “image”. Before it may be executed on a computing system, the image-based installation version may be activated.

The term “activation logic generator” as used herein may, in some embodiments, refer to a hardware component, a software component, or a combination of both, hardware and software component, adapted for generating an activation logic component without any manual blocks or interventions.

The term “executable image” as used herein may, in some embodiments, refer to a run-time image that is “ready to run” in a virtual environment. This means that all parameters may have been filled with values reflecting or characterizing the target system. In other words, the executable image may be an image-based installation version, which may have been activated or which may have been set into the status, in which it may be activated instantly.

The term “software product” as used herein may, in some embodiments, refer to a set of computer-readable instructions, which may be installed on an operating system. A software product may be self-contained and may be configurable using a plurality of parameters. The term “software product” may relate to conventional commercially available software products.

The term “point of variability” as used herein may, in some embodiments, refer to parameters or settings of a software product that may be changed in order to configure the software product for special purposes or special needs. Such points of variability may relate to specific hardware parameters, display sizes, certain database specifications or, may relate to specific software functionality that may be switched on or switched off for the specific software product. Basically, points of variability may define parameters or variables that may be set to specific values before a software product may be usable by an end user.

The term “point of variability knowledge base” as used herein may, in some embodiments, refer to a database, or in general, data storage, in which point of variability information may be stored. Typically, different software products or software components may have different points of variability. A software component may be identifiable by a software product identifier.

The term “system environment” as used herein may, in some embodiments, refer to a computing system or a set of computing systems working together to perform a defined task. In its simplest form, it may be a hardware server with known system components.

Scripts for activating an image in a target system environment be generated manually as part of the development process for a run-image comprising a software product, which may be a very time-consuming process. However, such an activation logic components may be required as part of the development process instead of generating the activation logic component on different target systems. In the context of deployed virtual system environments, compared to physical environments, automation of image distribution including an activation logic component may be a necessity. Installation of highly complex virtual computing environments may be much more efficient and it may automate the process of image deployments. Further, the generation of target activation scripts may be obsolete. This may reduce costs and effort in the process of distributing, activating and managing image-based systems running on hypervisors.

In some embodiments, an executable image of the image-based installation version may be created, the executable image being executable in the different system environment (i.e., a target system environment) using the image-based installation version and the activation logic component. Creation of an executable image may therefore be completely automated. The activation logic component may be generated automatically. In further embodiments, the software component may include a software product and an operating system. In such an embodiment, the entire system, including the operating system and the software product, may be activated on a hypervisor on a target system.

In some embodiments, analysis of the configuration settings of a software component may comprise loading a list of potential software products from a product library. The product library may comprise names or identifiers of software products that may have been installed on the underlying operating system. The product library may have stored an identifier, which is capable of identifying software products that may have been installed on the operating system. In further embodiments, the analysis may additionally comprise determining a software product identifier of the software component by comparing a first identifier of the list of potential products with a second identifier, which may be part of the installed software component. Doing this comparison, software that may actually be installed on the operating system may be determined and identified by the software product identifier. It may be possible to identify a plurality of software products and/or also versions of the operating system or, database and network products and version. The determining may also comprise determination of a version or release of the software product.

In further embodiments, a list of configuration options for the software component may be retrieved from a point of variability knowledge base. The software product identifier may be used as an entry point. The activation logic generator may automatically identify parameters and/or configuration settings, detect which values may have been changed or set, and determine all system environment specific parameter values related to the software product.

In further embodiments, the generation of the activation logic component may comprise determining variables characterizing the first system environment and using results of the determination of the variables for the creation of the activation logic component. In addition to identifying the software products specific variables, settings and parameters, computing system environment variables may also be identified. The computing system environment variable may need attention, and potentially different values related to the target system at time of activation on the target system. Such variables may include, for example, network identifiers, a hostname, security settings, and/or partitioning settings for a database. These variables are not directly related to the installed software products, may be used to characterize the computing system environment of the installed product.

Some embodiments may take the form of a computer program product, accessible from a computer-usable or computer-readable medium providing program code for use, by or in connection with a computer or any instruction execution system. For the purpose of this description, a computer-usable or computer-readable medium may be any apparatus that may contain means for storing the program for use, by or in a connection with the instruction execution system, apparatus, or device. Examples of a computer-readable medium may include a semi-conductor or solid state memory, magnetic tape, a removable computer diskette, a random access memory (RAM), a read-only memory (ROM), a rigid magnetic disk and an optical disk, including but not limited to compact disk-read only memory (CD-ROM), compact disk-read/write (CD-R/W), digital video disk (DVD), or Blu-Ray-Disk.

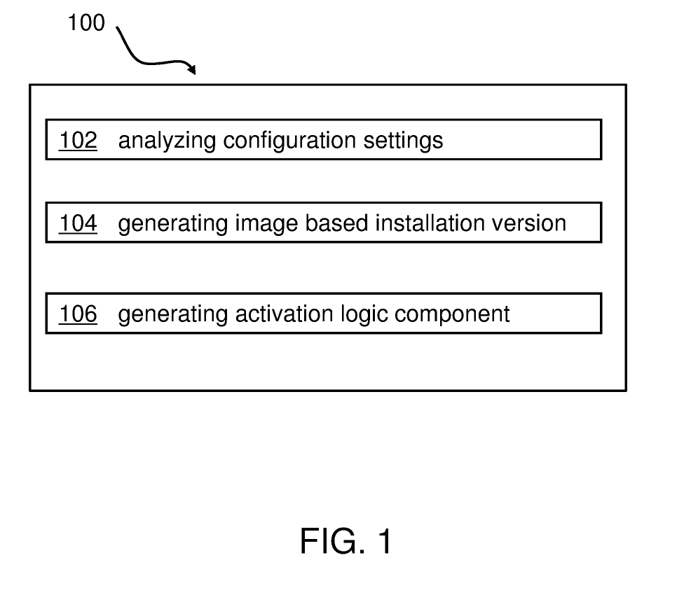

FIG. 1 shows a flowchart of an embodiment of a method 100 for generating an activation logic component for a software appliance. The method 100 comprises analyzing, in block 102, configuration settings of a software component, which may be installed in a first system environment—in particular a source computing system environment. Next, in block 104, an image based installation version of the software component is generated for a system environment comprising a target computing system environment, which may be different to the first system environment. Next, in block 106, an activation logic component is generated, such that the image-based installation version of the software component and the activation logic component may be generated by an activation logic generator. The building of the activation script or activation logic component may not be performed manually, but generated automatically by an active computing module.

In addition to the activation logic component in form of an activation script, a second activation component may be built during the process of generating an image-based installation version. The image-based installation version may be a basic run-time image, which may be activated. The second activation component may be part of the image-based installation version. Via this image-based installation version it may be decided—during the activation—which part of the image-based installation version may be activated to build the final activated image.

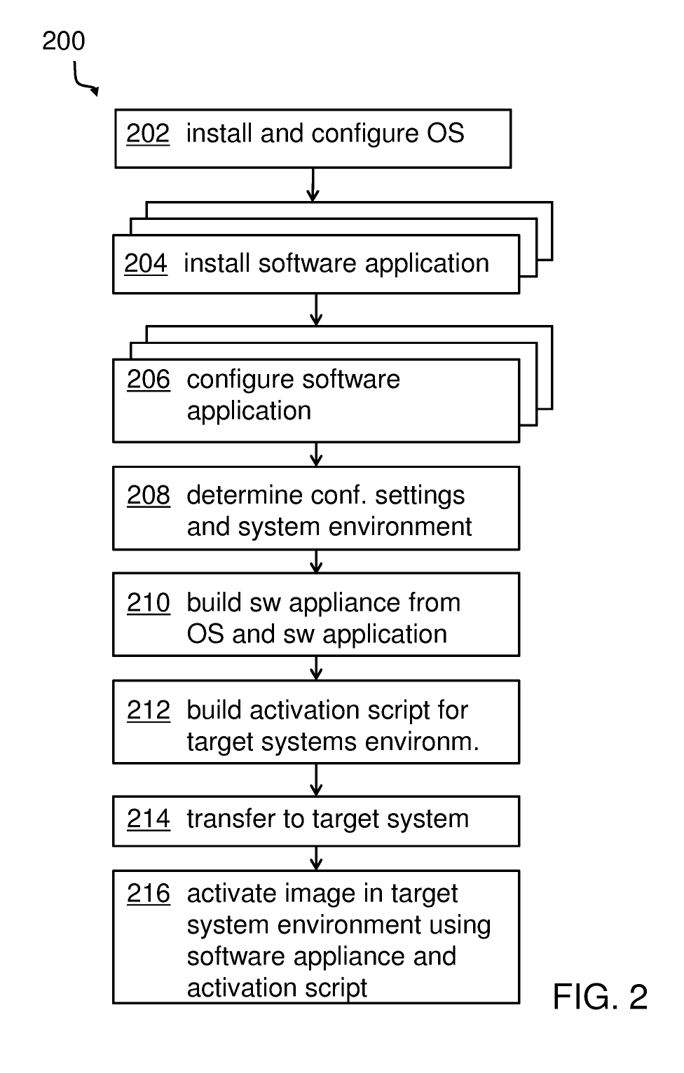

FIG. 2 shows a flowchart of an embodiment of a method 200 of manually building a software appliance and an activation script. Firstly, in block 202, a hypervisor may be installed on a hardware system, and on top of the hypervisor, an operating system (OS) may be installed and configured. Then, in block 204, one or more software application(s), software products, or software components may be installed on the operating system. These are then configured in block 206 according to a special purpose of the software appliance. Next, in block 208, configuration settings may be determined and performed in order to have the settings ready when building an activation script. Then, in block 210, a software appliance or image-based installation version is built. Then flow of method 200 proceeds to block 212, in which an activation script, or in other words, an activation logic component is built. Building of the activation script in block 212 may be a manual process using the manually determined configuration settings from block 208 and additional source system variables that may not be configuration settings of the software product, for example, a host name, network parameter values, or security settings. Next, in block 214, the software appliance is transferred to the target system, and, lastly, in block 216, the software appliance is activated on the target system by the activation script that was built manually in block 212.

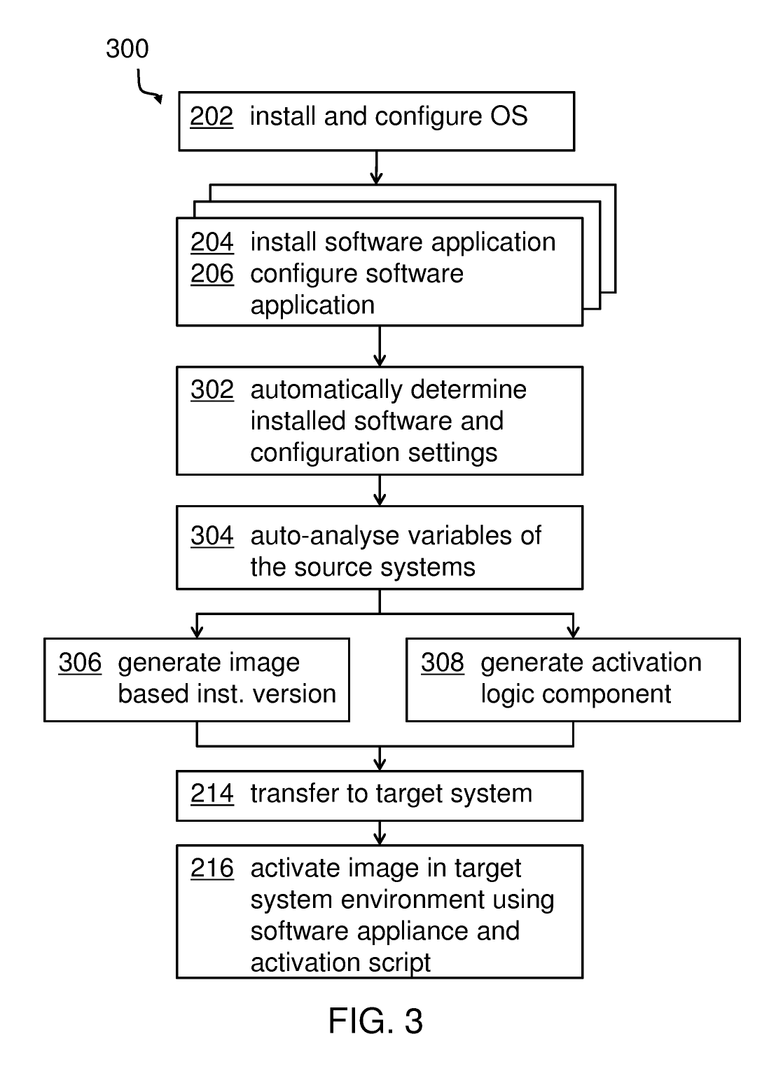

FIG. 3 shows a flowchart of an embodiment of a method 300 for automatic generation of an activation script (i.e., an activation logic component) in the context of method 200 of FIG. 2. Blocks discussed above with respect to method 200 of FIG. 2 are not discussed below with respect to FIG. 3; however, any of the blocks described above with respect to FIG. 2 may be included in various embodiments of method 300 of FIG. 3. Instead of a manual determination of configuration settings as is performed in block 208 of method 200 of FIG. 2, the configuration settings may be determined, in block 302 of FIG. 3, automatically using an activation logic generator. The activation logic generator may also determine, in block 304 of method 300, additional parameter settings of a source computing system or a computing environment. The activation logic generator may also generate, in block 306, an image-based installation version of the software application. Generation of the image-based installation version may be supported by guiding a user or developer though required activities. Additionally, the activation logic generator may generate, in block 308, an activation logic component in form of an activation script, which may be used to activate the image-based installation version on a target computing system, which may be difference to the source system environment (i.e., the first system environment). From block 308 of FIG. 3, flow may then proceed to blocks 214 and 216 of method 200 of FIG. 2; however, the activation script that is used in block 216 to activate the image is not built manually (as was discussed with respect to block 212) but automatically, as was discussed with respect to block 308 of FIG. 3.

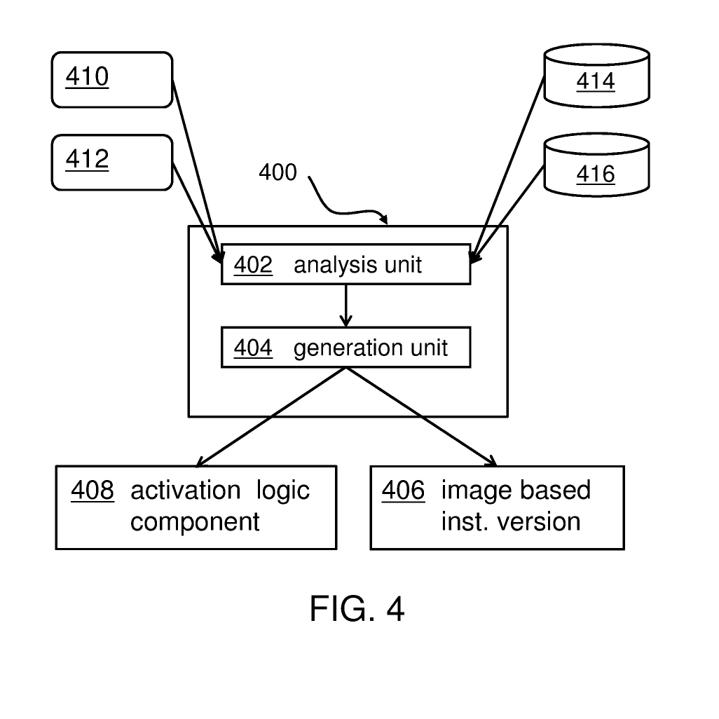

FIG. 4 shows an embodiment of an activation logic generator 400 for generating an activation logic component 408 for a software appliance. The activation logic generator 400 may comprise an analysis unit 402 adapted for analyzing configuration settings of a software component 410, which may be installed in a first system environment, i.e., a first computing environment comprising a hardware server, a hypervisor and other components. The analysis unit 402 may also be in communication with a product library 414. Product library 414 may comprise a list of software products that may be installed on the operating system. Using this information, the analysis unit 402 may determine which software component or software product may be installed. Furthermore, the analysis unit 402 may be in communication with a point of variability knowledge base 416, which may comprise information about potential configurations variable and values and storage to search for such configuration settings on a per software product basis. Additionally, the activation logic generator 400 may determine additional variables 412 from the first computing environment in which the software component is installed. The activation logic generator 400 may therefore have all required information to generate by the generation unit 404 an activation logic component that may later be used for an activation of an image-based installation version 406. This generation may be performed by the generation unit 404, which may generate the image-based installation version of the software component for a system environment different to the first system environment, i.e., the target system environment. The generation unit 404 may also generate the activation logic component. Thus, both the image-based installation version and the activation logic component 408 may be generated by the activation logic generator 400 automatically.

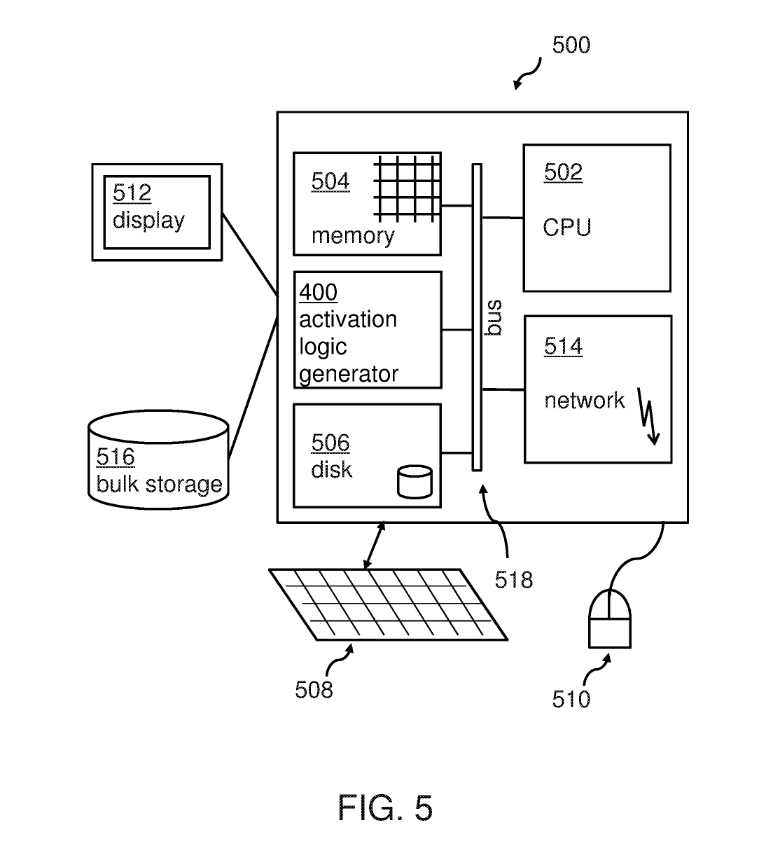

Embodiments of activation logic generation for a software appliance as discussed above may be implemented together with any appropriate type of computer, having any appropriate platform for storing and/or executing program code. For example, as shown in FIG. 5, a computing system 500 may include one or more processor(s) 502 with one or more cores per processor, associated memory elements 504, an internal storage device 506 (e.g., a hard disk, an optical drive such as a compact disk drive or digital video disk (DVD) drive, a flash memory stick, etc.), and numerous other elements and functionalities, typical of today's computers (not shown). The memory elements 504 may include a main memory, e.g., a random access memory (RAM), employed during actual execution of the program code, and a cache memory, which provides temporary storage of at least some program code and/or data in order to reduce the number of times, code and/or data must be retrieved from a long-term storage medium or external bulk storage 516 for an execution. Elements inside the computer 500 may be linked together by means of a bus system 518 with corresponding adapters. Additionally, the activation logic generator 400 may be attached to the bus system 518.

The computing system 500 may also include input means, such as a keyboard 508, a pointing device such as a mouse 510, or a microphone (not shown). Alternatively, the computing system may be equipped with a touch sensitive screen as main input device. Furthermore, the computer 500, may include output means, such as a monitor or screen 512 [e.g., a liquid crystal display (LCD), a plasma display, a light emitting diode display (LED), or cathode ray tube (CRT) monitor]. The computer system 500 may be connected to a network (e.g., a local area network (LAN), a wide area network (WAN), such as the Internet or any other similar type of network, including wireless networks via a network interface connection 514. This may allow a coupling to other computer systems or a storage network or a tape drive. Those, skilled in the art will appreciate that many different types of computer systems exist, and the aforementioned input and output means may take other forms. Generally speaking, the computer system 500 may include any appropriate processing, input and/or output means.

Further, one or more elements of the aforementioned computer system 700 may be located at a remote location and connected to the other elements over a network. Further, some embodiments may be implemented on a distributed system having a plurality of nodes, where various functions may be located on a different node within the distributed system. In one embodiment, a node corresponds to a computer system. Alternatively, the node may correspond to a processor with associated physical memory. The node may alternatively correspond to a processor with shared memory and/or resources or a smartphone.

Further, software instructions to perform embodiments of activation logic generation for a software appliance may be stored on a computer readable medium, such as a compact disk (CD), a diskette, a tape, or any other computer readable storage device.

It should also be noted that the term “comprising” does not exclude other elements or blocks and “a” or “an” does not exclude a plurality. On the other side, the term “comprising” may also include the case of “consisting of”. Also, elements described in association with different embodiments may be combined. It should also be noted that reference signs in the claims should not be construed as limiting elements.

The technical effects and benefits of exemplary embodiments include automatic installation and configuration of a software appliance across a variety of computing systems.

The terminology used herein is for the purpose of describing particular embodiments only and is not intended to be limiting of the claims. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, blocks, operations, elements, and/or components, but do not preclude the presence or addition of one or more other features, integers, blocks, operations, elements, components, and/or groups thereof.

The corresponding structures, materials, acts, and equivalents of all means or block plus function elements in the claims below are intended to include any structure, material, or act for performing the function in combination with other claimed elements as specifically claimed. The description has been presented for purposes of illustration and description, but is not intended to be exhaustive or limited in the form disclosed. Many modifications and variations will be apparent to those of ordinary skill in the art without departing from the scope and spirit of the disclosure. The embodiment was chosen and described in order to best explain the principles and the practical application, and to enable others of ordinary skill in the art to understand the disclosure for various embodiments with various modifications as are suited to the particular use contemplated.

1. A method for generating an activation logic component for a software appliance, the method comprising:
analyzing configuration settings of a software component, the software component being installed in a first system environment;
generating an image-based installation version of the software component for a second system environment, the second system environment being distinct from the first system environment; and
generating the activation logic component, such that the image-based installation version of the software component and the activation logic component are generated by an activation logic generator.

2. The method of claim 1, further comprising creating an executable image of the image-based installation version, the executable image being executable in the second system environment using the image-based installation version and the activation logic component.

3. The method of claim 1, wherein the software component comprises a software product and an operating system.

4. The method of claim 1, wherein the analyzing of the configuration settings comprises loading a list of potential software products from a product library.

5. The method of claim 4, wherein the analyzing of the configuration settings further comprises determining a software product identifier of the software component by comparing a first identifier of the list of potential software products with a second identifier being part of the software component.

6. The method of claim 5, the method further comprising retrieving, using the software product identifier, from a point of variability knowledge base, a list of configuration options for the software component.

7. The method of claim 1, wherein the generating of the activation logic component further comprises determining a set of variables characterizing the first system environment and using results of the determination of the set of variables for the creation of the activation logic component.

8. A system comprising an activation logic generator for generating an activation logic component for a software appliance, the activation logic generator comprising:
an analysis unit configured to analyze configuration settings of a software component, the software component being installed in a first system environment,
a generation unit configured to generate an image-based installation version of the software component for a second system environment, the second system environment being distinct from the first system environment, and to generate the activation logic component, such that the image-based installation version of the software component and the activation logic component are generated by the activation logic generator.

9. The system of claim 8, wherein the system if further configured to create an executable image of the image-based installation version, the executable image being executable in the second system environment using the image-based installation version and the activation logic component.

10. The system of claim 8, wherein the software component comprises a software product and an operating system.

11. The system of claim 8, wherein the analyzing of the configuration settings comprises loading a list of potential software products from a product library.

12. The system of claim 11, wherein the analyzing of the configuration settings further comprises determining a software product identifier of the software component by comparing a first identifier of the list of potential software products with a second identifier being part of the software component.

13. The system of claim 12, wherein the system is further configured to retrieve, using the software product identifier, from a point of variability knowledge base, a list of configuration options for the software component.

14. The system of claim 8, wherein the generating of the activation logic component further comprises determining a set of variables characterizing the first system environment and using results of the determination of the set of variables for the creation of the activation logic component.

15. A computer program product for generating an activation logic component for a software appliance, the computer program product comprising:
a computer readable storage medium having computer readable program code configured to:
analyze configuration settings of a software component, the software component being installed in a first system environment;
generate an image-based installation version of the software component for a second system environment, the second system environment being distinct from the first system environment; and
generate the activation logic component, such that the image-based installation version of the software component and the activation logic component are generated by an activation logic generator.

16. The computer program product of claim 15, further comprising creating an executable image of the image-based installation version, the executable image being executable in the second system environment using the image-based installation version and the activation logic component.

17. The computer program product of claim 15, wherein the software component comprises a software product and an operating system.

18. The computer program product of claim 15, wherein the analyzing of the configuration settings comprises loading a list of potential software products from a product library.

19. The computer program product of claim 18, wherein the analyzing of the configuration settings further comprises determining a software product identifier of the software component by comparing a first identifier of the list of potential software products with a second identifier being part of the software component.

20. The computer program product of claim 19, further comprising retrieving, using the software product identifier, from a point of variability knowledge base, a list of configuration options for the software component.
